(19) United States
(12) Patent Application Publication
(10) Pub. No.: US 2022/0049053 A1
(43) Pub. Date: Feb. 17, 2022

(54) POLYAMIDE, COMPOSITIONS AND CORRESPONDING MOBILE ELECTRONIC DEVICE COMPONENTS

(71) Applicant: SOLVAY SPECIALTY POLYMERS USA, LLC, Alpharetta, GA (US)

(72) Inventors: Nancy J. SINGLETARY, Alpharetta, GA (US); Stéphane JEOL, Saint-Genis-Laval (FR); Joel FLORES, Alpharetta, GA (US); Joel POLLINO, Johns Creek, GA (US)

(21) Appl. No.: 17/426,640

(22) PCT Filed: Feb. 19, 2020
(86) PCT No.: PCT/EP2020/054363

§ 371 Date: Jul. 29, 2021

Related U.S. Application Data
(60) Provisional application No. 62/807,409, filed on Feb. 19, 2019.

(30) Foreign Application Priority Data
May 2, 2019 (EP) 19172330.3

(51) Int. Cl. C08G 69/26; C08K 7/14; C08G 69/14

(52) U.S. Cl. CPC C08G 69/26; C08G 69/14; C08K 7/14

(57) ABSTRACT

The present invention relates to polyamides (PA) comprising recurring units (R_{PA}) according to formula (I) or formula (II):

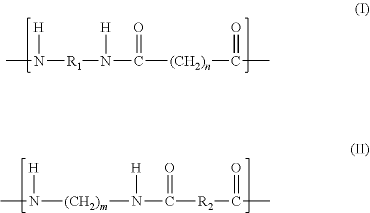

wherein n equals 16; m equals 18; R₁ is 1,4-bis(methyl)cyclohexane; and R₂ is 1,4-bis(methyl)cyclohexane. The present invention also relates to polymer compositions (C) comprising such polyamides, and to articles, for example mobile electronic device articles and components, incorporating the polyamides (PA) or compositions (C).

### RELATED APPLICATIONS

This application claims priority to U.S. provisional application No. 62/807,409 filed on Feb. 19, 2019, and to EP patent application No. 19172330.3, filed on May 2, 2019, the whole content of these applications being incorporated herein by reference for all purposes.

### TECHNICAL FIELD

The present invention relates to polyamides (PA) comprising recurring units (R_{PA}) according to formula (I) or formula (II):

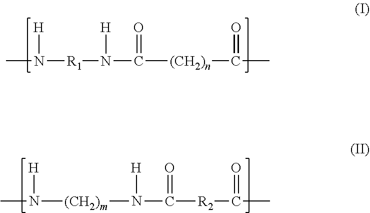

wherein
n equals 16;
m equals 18;
R₁ is 1,4-bis(methyl)cyclohexane; and
R₂ is 1,4-bis(methyl)cyclohexane.

The present invention also relates to a polymer compositions comprising such polyamides, and to mobile electronic device components incorporating the polyamide compositions.

### BACKGROUND ART

Due to their reduced weight and high mechanical performance, polymer compositions are widely used to manufacture mobile electronic device components. There is now a high demand from the market for polymer compositions to be used to manufacture mobile electronic device components having improved dielectric performances (i.e. low dielectric constants and dissipation factor).

In mobile electronic devices, the material forming the various components and housing can significantly degrade wireless radio signals (e.g. 1 MHz, 2.4 GHz and 5.0 GHz frequencies) transmitted and received by the mobile electronic device through one or more antennas. The dielectric performances of the material to be used in mobile electronic devices can be determined by measuring the dielectric constant as it represents the ability of the material to interact with the electromagnetic radiation and disrupt electromagnetic signals (e.g. radio signals) travelling through the material. Accordingly, the lower the dielectric constant of a material at a given frequency, the less the material disrupts the electromagnetic signal at that frequency.

The Applicant has identified a new class of polyamides having improved dielectric performances, which make them notably well-suited as materials for mobile electronic device components.

These polyamides can notably derive from 1,4-bis(aminomethyl)cyclohexane diamine (1,4-BAMC), and at least one long chain aliphatic dicarboxylic acid which is HOOC—(CH₂)₁₆—COOH.

The article from Kazuo Saotone and Hiroshi Komoto (Journal of Polymer Science, Vol 5, 107-117, 1967) describes the preparation of N-Alkyl-substituted polyamides and copolyamides from N,N′-dialkyl p-xylylenediamines and N,N′-dialkyl hexamethylene diamine (in which the alkyl is specifically methyl or ethyl) with long chain aliphatic dicarboxylic acids. The article also describes the preparation of N-alkyl copolyamides which are found to be crystalline over the whole range of compositions.

The article from Heidecker et al. (Antec 2002, Vol 3, 3624-3628) relates to liquid crystalline polymers, obtained by blending various aliphatic and aromatic diamines with a ratio of 4,4-dimethyl bibenzoate and 1,18-octadecanedioic acid (C18 diacid).

The patent CA 2 565 483 (Degussa) describes the preparation of various semi-crystalline polyamides, starting from m-xylylenediamine, notably polyamide MXD14 and MXD18.

The patent application EP 2 562 203 A1 (Mitsubishi) relates to a polyamide comprising a cycloaliphatic diamine unit (I), a linear or aromatic dicarboxylic acid unit (II) and a constituent unit represented by formula (III) —[NH—CHR—CO]—. The cycloaliphatic diamine unit (I) is derived from bis(aminomethyl)cyclohexane, such as 1,3-bis(aminomethyl)cyclohexane (1,3-BAC) and/or 1,4-bis(aminomethyl)cyclohexane (1,4-BAC). The dicarboxylic acid unit may be linear or aromatic. When it is linear, the dicarboxylic acid is such that it has between 4 and 20 carbon atoms, preferably 5 to 18, more preferably 6 to 14, even more preferably 6 to 10. Adipic acid, sebacic and dodecanedioic acids are used in the examples. This document does not describe a polyamide derived from 1,4-bis(aminomethyl)cyclohexane diamine and 1,18-octadecanedioic acid.

The U.S. Pat. No. 3,992,360 (Hoechst) relates to a transparent polyamide obtained by the condensation of 1,3-bis(aminomethyl)cyclohexane, which can be partly substituted by 1,4-bis(aminomethyl)cyclohexane. A straight chain or branched dicarboxylic acid having from 2 to 20 carbon atoms, preferably 6 to 12 carbon atoms (preferably adipic acid or decanedioic acid) may be used for the preparation of the polyamide. This document does not describe a polyamide derived from 1,4-bis(aminomethyl)cyclohexane diamine and 1,18-octadecanedioic acid.

None of the above-listed documents describe however the polyamides of the present invention and their advantageous properties (melting temperature, dielectric performances and transparency).

### SUMMARY OF INVENTION

The present invention relates to a polyamide (PA), comprising recurring units (R_{PA}) according to formula (I) or formula (II):

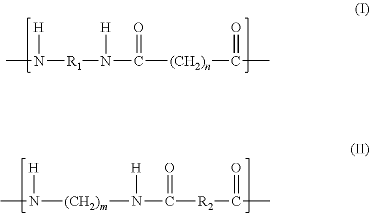

wherein:
n equals 16,
m equals 18,
R₁ is 1,4-bis(methyl)cyclohexane, and
R₂ is 1,4-bis(methyl)cyclohexane.

Preferably, the polyamide is the condensation product of a mixture comprising:
at least one diamine component which contains at least 50 mol. % of 1,4-bis(aminomethyl)cyclohexane diamine, and
at least one dicarboxylic acid component which contains at least 50 mol. % of HOOC—(CH₂)₁₆—COOH, or derivative thereof.

According to an embodiment, the polyamide (PA) or the composition (C) incorporating this polyamide (PA) has a dielectric constant ε at 2.4 GHz of less than 3.0, as measured according to ASTM D2520 (2.4 GHz), and/or a dissipation factor (Df) at 2.4 GHz of less than 0.010, as measured according to ASTM D2520 (2.4 GHz).

The present invention also relates to an article comprising the polyamide of the invention or incorporating this polyamide (PA). The article may for example be selected in the group consisting of mobile phone, a personal digital assistant, a laptop computer, a tablet computer, a wearable computing device, a camera, a portable audio player, a portable radio, a global position system receiver, and a portable game console.

### DISCLOSURE OF THE INVENTION

Described herein are polyamides (PA), for example derived from 1,4-bis(aminomethyl)cyclohexane diamine (1,4-BAMC), and at least one dicarboxylic acid HOOC—(CH₂)ₙ—COOH, wherein n equals 16, as well as polyamide compositions (C), including this polyamide and, optionally glass fibers and one or more additives. The polyamides (PA) of the present invention have low dielectric constant Dk (high dielectric performance). The polyamides (PA) described herein can be incorporated into mobile electronic device articles or components.

According to an embodiment, the polyamide (PA) or polyamide composition (C) preferably has a dielectric constant Dk at 2.4 GHz of less than 3.0, preferably less than 2.9, less than 2.8, less than 2.7 or less than 2.65, as measured as measured according to ASTM D2520 (2.4 GHz).

The polyamide (PA) of the present invention comprises recurring units (R_{PA}) of formula (I) or formula (II):

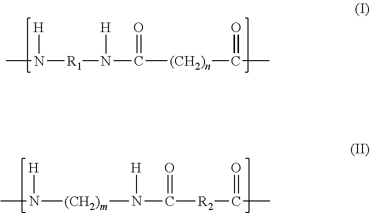

wherein

n equals 16,

m equals 18,

R₁ is 1,4-bis(methyl)cyclohexane and

R₂ is 1,4-bis(methyl)cyclohexane.

The polyamide (PA) of the present disclosure may be a polyamide consisting essentially in recurring units (R_{PA}) or a copolyamide (PA) comprising recurring units (R_{PA}). More precisely, the expression “copolyamide” is hereby used for designating copolyamides comprising recurring units (R_{PA}), for example derived from 1,4-bis(aminomethyl)cyclohexane diamine (1,4-BAMC), and at least one dicarboxylic acid HOOC—(CH₂)ₙ—COOH, wherein n equals 16, as well as recurring units (R_{PA}*), distinct from recurring units (R_{PA}).

According to an embodiment, the polyamide (PA) consists essentially in recurring units (R_{PA}) of formula (I) where R1 is 1,4-bis(methyl)cyclohexane, for example derived from 1,4-bis(aminomethyl)cyclohexane diamine (1,4-BAMC) and 1,18-octadecanedioic acid.

When the polyamide (PA) comprises recurring units (R_{PA}*), the recurring unit (R_{PA}*) may be of formula (Ill) and/or (IV):

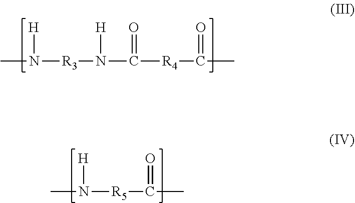

wherein

R₃ is selected from the group consisting of a bond, a C₁-C₁₅ alkyl and a C₆-C₃₀ aryl, optionally comprising one or more heteroatoms (e.g. O, N or S) and optionally substituted with one or more substituents selected from the group consisting of halogen (e.g. fluorine, chlorine, bromine or iodine), hydroxy (—OH), sulfo (—SO₃M) (e.g. wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl;

R₄ is selected from the group consisting of a C₁-C₂₀ alkyl and a C₆-C₃₀ aryl, optionally comprising one or more heteroatoms (e.g. O, N or S) and optionally substituted with one or more substituents selected from the group consisting of halogen (e.g. fluorine, chlorine, bromine or iodine), hydroxy (—OH), sulfo (—SO₃M) (e.g. wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl; and

R₅ is selected from the group consisting of a linear or branched C₂-C₁₄ alkyl, optionally comprising one or more heteroatoms (e.g. O, N and S) and optionally substituted with one or more substituents selected from the group consisting of halogen (e.g. fluorine, chlorine, bromine and iodine), hydroxy (—OH), sulfo (—SO₃M) (e.g. wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl.

The polyamide (PA) of the present invention may be of formula (V) or (VI):

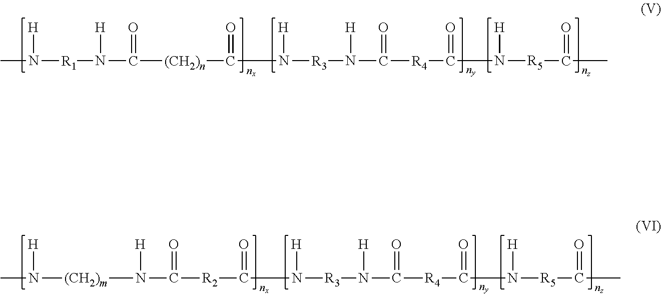

wherein

nₓ, n_{y} and n_{z} are respectively the moles % of each recurring units x, y and z;

recurring units x, y and z are arranged in blocks, in alternation or randomly;

nₓ+n_{y}+n_{z}=100;

5≤nₓ≤100;

R₁, R₂, R₃, R₄ and R₅ being as described above.

The polyamides (PA) of the present invention may have a number average molecular weight Mn ranging from 1,000 g/mol to 40,000 g/mol, for example from 2,000 g/mol to 35,000 g/mol or from 4,000 to 30,000 g/mol. The number average molecular weight Mn can be determined by gel permeation chromatography (GPC) using ASTM D5296 with polystyrene standards.

In the polyamide (PA) of the present disclosure, the recurring unit y may be aliphatic or aromatic. For the purpose of the present invention, the expression “aromatic recurring unit” is intended to denote any recurring unit that comprises at least one aromatic group. The aromatic recurring units may be formed by the polycondensation of at least one aromatic dicarboxylic acid with an aliphatic diamine or by the polycondensation of at least one aliphatic dicarboxylic acid with an aromatic diamine, or by the polycondensation of aromatic aminocarboxylic acids. For the purpose of the present invention, a dicarboxylic acid or a diamine is considered as “aromatic” when it comprises one or more than one aromatic group.

In the polyamide (PA) of the present disclosure, the recurring unit z is aliphatic and R₅ is a linear or branched C₂-C₁₄ alkyl, optionally comprising one or more heteroatoms (e.g. O, N and S) and optionally substituted with one or more substituents selected from the group consisting of halogen, hydroxy, sulfo, C₁-C₆ alkoxy, C₁-C₆ alkylthio, C₁-C₆ acyl, formyl, cyano, C₆-C₁₅ aryloxy and C₆-C₁₅ aryl.

The polyamide (PA) of the present invention may be composed of recurring units x and y, or of recurring units x and z, or of recurring units x, y and z. Recurring units x, y and z are arranged in blocks, in alternation or randomly.

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

Throughout this document, all temperatures are given in degrees Celsius (° C.).

Unless specifically limited otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cycloaromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

According to an embodiment, the polyamide (PA) is the condensation product of a mixture comprising:
at least one diamine component which contains at least 5 mol. % of 1,4-BAMC, based on the total number of moles in the diamine component,
(or at least 10 mol. %, at least 15 mol. %, at least 20 mol. %, at least 25 mol. %, at least 30 mol. %, at least 35 mol. %, at least 40 mol. %, at least 45 mol. %, at least 50 mol. %, at least 55 mol. %, at least 60 mol. %, at least 65 mol. %, at least 70 mol. %, at least 75 mol. %, at least 80 mol. %, at least 85 mol. %, at least 90 mol. %, at least 95 mol. % or at least 98 mol. % of 1,3-BAMC and/or 1,4-BAMC), and
at least one dicarboxylic acid component which contains at least 5 mol. % of HOOC—(CH₂)₁₆—COOH, or derivative thereof, based on the total number of moles in the dicarboxylic acid component,
(or at least 10 mol. %, at least 15 mol. %, at least 20 mol. %, at least 25 mol. %, at least 30 mol. %, at least 35 mol. %, at least 40 mol. %, at least 45 mol. %, at least 50 mol. %, at least 55 mol. %, at least 60 mol. %, at least 65 mol. %, at least 70 mol. %, at least 75 mol. %, at least 80 mol. %, at least 85 mol. %, at least 90 mol. %, at least 95 mol. % or at least 98 mol. % of HOOC—(CH₂)₁₆—COOH).

According to an embodiment, the polyamide (PA) is the condensation product of a mixture comprising at least one of the components selected from the group consisting of:
at least one dicarboxylic acid component (also called hereby diacid) or derivative thereof, and at least one diamine component,
at least one aminocarboxylic acid, and
at least one lactam.

The polyamide (PA) of the present invention may for example comprise at least 5 mol. % of recurring units (R_{PA}), for example derived from 1,4-BAMC, and at least one dicarboxylic acid HOOC—(CH₂)₁₆—COOH, for example at least about 10 mol. %, at least about 15 mol. %, at least about 20 mol. %, at least about 25 mol. %, at least about 30 mol. %, at least about 35 mol. %, at least about 40 mol. %, at least about 45 mol. %, at least about 50 mol. %, at least about 55 mol. %, at least about 60 mol. %, at least about 65 mol. %, at least about 70 mol. %, at least about 75 mol. %, at least about 80 mol. %, at least about 85 mol. %, at least about 90 mol. %, at least about 95 mol. % or at least about 98 mol. %.

The polyamide (PA) of the present disclosure may be a polyamide consisting essentially in recurring units (R_{PA}). In such case, the polyamide comprises less than 2 mol. % of recurring units distinct from recurring units (R_{PA}), for example less than 1 mol. %, less than 0.5 mol. % or even less than 0.1 mol. % of recurring units distinct from recurring units (R_{PA}).

The expression “at least” is hereby intended to denote “equals to or more than”. For example, the expression “at least 5 mol. % of recurring units (R_{PA})” hereby denotes that the polyamide (PA) may comprise 5 mol. % of recurring units (R_{PA}) or more than 5 mol. % of recurring units (R_{PA}). The expression “at least” therefore corresponds to the mathematical symbol “≥” in the context of the present invention.

The expression “less than” corresponds to the mathematical symbol “<” in the context of the present invention. For example, the expression “less than 100 mol. % of recurring units (R_{PA})” hereby denotes that the polyamide comprises strictly less than 100 mol. % of recurring units (R_{PA}) and therefore qualify as a copolyamide, made from recurring units (R_{PA}) and at least one another recurring unit (R_{PA}*).

According to this embodiment, the dicarboxylic acid component can be chosen among a large variety of aliphatic or aromatic components comprising at least two acidic moieties —COOH. According to this embodiment, the diamine component can be chosen among a large variety of aliphatic or aromatic components comprising at least two amine moieties —NH₂.

The expression “derivative thereof” when used in combination with the expression “dicarboxylic acid” is intended to denote whichever derivative which is susceptible of reacting in polycondensation conditions to yield an amide bond. Examples of amide-forming derivatives include a mono- or di-alkyl ester, such as a mono- or di-methyl, ethyl or propyl ester, of such carboxylic acid; a mono- or di-aryl ester thereof; a mono- or di-acid halide thereof; a carboxylic anhydride thereof and a mono-or di-acid amide thereof, a mono- or di-carboxylate salt.

Non limitative examples of aliphatic diacarboxylic acids are notably oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tridecanedioic acid [HOOC—(CH₂)₁₁—COOH], tetradecanedioic acid [HOOC—(CH₂)₁₂—COOH], pentadecanedioic acid [HOOC—(CH₂)₁₃—COOH], hexadecanedioic acid [HOOC—(CH₂)₁₄—COOH], octadecanedioic acid [HOOC—(CH₂)₁₆—COOH]. Included in this category are also cycloaliphatic dicarboxylic acids such as 1,4-cyclohexane dicarboxylic acid and 1,3-cyclohexane dicarboxylic acid.

Non limitative examples of aromatic diacids are notably phthalic acids, including isophthalic acid (IPA), terephthalic acid (TPA), naphthalendicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene.

Non limitative examples of aromatic diamines (NNₐᵣ) are notably m-phenylene diamine (MPD), p-phenylene diamine (PPD), 3,4′-diaminodiphenyl ether (3,4′-ODA), 4,4′-diaminodiphenyl ether (4,4′-ODA), p-xylylene diamine (PXDA) and m-xylylenediamine (MXDA).

Non limitative examples of aliphatic diamines (NNₐₗ) are notably 1,2-diaminoethane, 1,2-diaminopropane, propylene-1,3-diamine, 1,3-diaminobutane, 1,4-diaminobutane (putrescine), 1,5-diaminopentane (cadaverine), 2-methyl-1,5-diaminopentane, hexamethylenediamine (or 1,6-diaminohexane), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12 diaminododecane, 1,13 diaminotridecane, 2,5-diamonotetrahydrofurane and N,N-Bis(3-aminopropyl)methylamine. Included in this category are also cycloaliphatic diamine such as isophorone diamine, 1,3-diaminocyclohexane, 1,4-diaminocyclohexane, bis-p-aminocyclohexylmethane, 1,3-bis(aminomethyl)cyclohexane, 1,4-bis(aminomethyl)cyclohexane, bis(4-amino-3-methylcyclohexyl) methane (MACM) and bis(4-aminocyclohexyl)methane (MACM).

The aliphatic diamines (NNₐₗ) can also be selected in the group of polyetherdiamines. The polyetherdiamines can be based on an ethoxylated (EO) backbone and/or on a propoxylated (PO) backbone and they can be ethylene-oxide terminated, propylene-oxide terminated or butylene-oxide terminated diamines. Such polyetherdiamines are for example sold under the trade name Jeffamine® and Elastamine® (Hunstman).

According to an embodiment of the present invention, the polyamide (PA) comprises at least one aminocarboxylic acid (recurring unit z), and/or at least one lactam (recurring unit z).

The aminocarboxylic acid may have from 3 to 15 carbon atoms, for example from 4 to 13 carbon atoms. According to an embodiment, the aminocarboxylic acid is selected from the group consisting of 6-amino-hexanoic acid, 9-aminononanoic acid, 10-aminodecanoic acid, 11-aminoundecanoic acid, 12-aminododecanoic acid, 13-aminotridecanoic acid, 3-(aminomethyl)benzoic acid, 4-(aminomethyl)benzoic acid and mixture thereof.

The lactam may have from 3 to 15 carbon atoms, for example from 4 to 13 carbon atoms. According to an embodiment, the lactam is selected from the group consisting of caprolactam, laurolactam, and mixture thereof.

According to an embodiment, the polyamide (PA) is the condensation product of a mixture comprising:
at least 5 mol. % of 1,4-BAMC,
at least 5 mol. % of one dicarboxylic acid (DA) HOOC—(CH₂)₁₆—COOH, or derivative thereof,
at least one additional dicarboxylic acid component, distinct from (DA), and
at least one additional diamine component, distinct from 1,4-BAMC, wherein
the additional dicarboxylic acid component is selected from the group consisting of adipic acid, azelaic acid, sebacic acid, dodecanedioic acid, 1,4-cyclohexanedioic acid, isophthalic acid, terephthalic acid, 2,6-naphthalene dicarboxylic acid, 4,4′-bibenzoic acid, 5-hydroxyisophthalic acid, 5-sulfophthalic acid, and mixture thereof, and
the additional diamine component is selected from the group consisting of 1,4-diaminobutane, 1,5-diamonopentane, 2-methyl-1,5diaminopentane, hexamethylenediamine, 1,9-diaminononane, 2-methyl-1,8-diaminooctoane, 1,10-diaminedecane, 1,12-diaminododecane, H₂N—(CH₂)₃—O—(CH₂)₂—O(CH₂)₃—NH₂, m-xylylene diamine, p-xylylene and mixture thereof.

According to another embodiment, the polyamide is the condensation product of a mixture comprising:
at least 5 mol. % of 1,4-BAMC,
at least 5 mol. % of one dicarboxylic acid (DA) HOOC—(CH₂)₁₆—COOH, or derivative thereof,
at least one additional dicarboxylic acid component, distinct from (DA), and
at least one additional diamine component, distinct from 1,4-BAMC, wherein
the additional dicarboxylic acid component is selected from the group consisting of adipic acid, terephthalic acid, isopthalic acid and mixture thereof, and
the additional diamine component is selected from the group consisting of hexamethylenediamine, m-xylylene diamine, 1,10-decamethylene diamine and mixture thereof.

According to another embodiment, the polyamide (PA) is the condensation product of a mixture comprising:
at least 5 mol. % of 1,4-BAMC,
at least 5 mol. % of one dicarboxylic acid (DA) HOOC—(CH₂)₁₆—COOH, or derivative thereof,
at least one lactam or aminoacid selected from the group consisting of caprolactam, laurolactam, 11-aminoundecanoic acid, 3-(aminomethyl)benzoic acid and mixture thereof.

According to a preferred embodiment, the polyamide (PA) comprises at least 50 mol. % of recurring units (R_{PA}), for example at least 60 mol. %, at least 70 mol. %, at least 75 mol. % of recurring units (R_{PA}). According to this embodiment, the polyamide (R_{PA}) is such that, in formulas (V) or (VI):

50≤nₓ≤100,

60≤nₓ≤100,

70≤nₓ≤100 or

75≤nₓ≤100.

The polyamide of the present invention may comprise less than 100 mol. % of recurring units (R_{PA}).

According to another preferred embodiment, the polyamide (PA) comprises less than 99 mol. % of recurring units (R_{PA}), for example less than 98 mol. %, less than 97 mol. %, less than 96 mol. % of recurring units (R_{PA}). According to this embodiment, the polyamide (PA) is such that, in formulas (V) or (VI):

5≤nₓ≤99,

5≤nₓ≤98,

5≤nₓ≤97 or

5≤nₓ≤96.

nₓ, n_{y} and n_{z} are respectively the moles % of each recurring units x, y and z. As an example of the different embodiments of the present invention, if the polyamide (PA) of the present invention is composed exclusively of recurring units x and y, then nₓ+n_{y}=100 and n_{z}=0. In this case, the recurring unit y is composed of a diamine component and a diacid component; the number of moles of diamines and the number of moles of diacids to be added to the condensation reaction are equal. For example, if the polyamide is composed exclusively of 1,4-BAMC, and dicarboxylic acid (DA) HOOC—(CH₂)₁₆—COOH, as well as terephthalic acid and hexamethylenediame, with nₓ=60 mol. % and n_{y}=40 mol. %, then substantially the same number of moles of terephtalic acid and hexamethylenediamine should be added to the condensation mixture, that is to say 40 mol. %. The term “substantially” is hereby intended to denote that the ratio diacid/diamine varies between 0.9 to 1.1, for example between 0.95 and 1.05.

According to an embodiment, the polyamide (PA) of the present invention has a glass transition temperature of at least about 50° C., as determined according to ASTM D3418, for example at least about 58° C., at least about 60° C. or at least about 62° C.

According to an embodiment, the polyamide (PA) of the present invention has a melting temperature (Tm) of at least about 150° C., as determined according to ASTM D3418, for example at least about 152° C., at least about 154° C.

According to an embodiment, the polyamide (PA) of the present invention has:
a dielectric constant (Dk) at 2.4 GHz of less than 3.0, preferably less than 2.9 or less than 2.8, as measured according to ASTM D2520 (2.4 GHz), and or
a dissipation factor (Df) at 2.4 MHz of less than 0.010, preferably less than 0.009, less than 0.0087 or less than 0.0085, as measured according to ASTM D2520 (2.4 GHz).

According to an embodiment, the polyamide (PA) of the present invention has a light transmission (also called transparency) of at least 50%, preferentially at least 60%, preferentially at least 70% at 1 mm as measured according to ASTM D 1003.

The polyamide (PA) described herein can be prepared by any conventional method adapted to the synthesis of polyamides and polyphthalamides.

Preferentially, the polyamide of the invention is prepared by reacting by heating the monomers in presence of less than 40 wt. % of water, preferentially less than 30 wt. %, less than 20 wt. %, less than 10 wt. %, preferentially with no added water, up to a temperature of at least Tm+10° C., Tm being the melting temperature of the polyamide.

The polyamide (PA) described herein can for example be prepared by thermal polycondensation of aqueous solution of monomers and comonomers. The copolyamides may contain a chain limiter, which is a monofunctional molecule capable of reacting with the amine or carboxylic acid moiety, and is used to control the molecular weight of the copolyamide. For example, the chain limiter can be acetic acid, propionic acid, benzoic acid and/or benzylamine. A catalyst can also be used. Examples of catalyst are phosphorous acid, ortho-phosphoric acid, meta-phosphoric acid, alkali-metal hypophosphite such as sodium hypophosphite and phenylphosphinic acid. A stabilizer, such as a phosphite, may also be used.

The polyamide (PA) described herein can also advantageously be prepared by a solvent-free process, that-is-to-say a process conducted in the melt, in the absence of a solvent. When the condensation is solvent-free, the reaction can be carried out in equipment made from materials inert toward the monomers. In this case, the equipment is chosen in order to provide enough contact of the monomers, and in which the removal of volatile reaction products is feasible. Suitable equipment includes agitated reactors, extruders and kneaders.

Polyamide Composition (C)

The polyamide composition (C) comprises the polyamide (PA) of the present invention, above described.

The polyamides may be present in the composition (C) in a total amount of greater than 30 wt. %, greater than 35 wt. % by weight, greater than 40 wt. % or greater than 45 wt. %, based on the total weight of the polymer composition (C).

The polyamides may be present in the composition (C) in a total amount of less than 99.95 wt. %, less than 99 wt. %, less than 95 wt. %, less than 90 wt. %, less than 80 wt. %, less than 70 wt. % or less than 60 wt. %, based on the total weight of the polymer composition (C).

The polyamides may for example be present in the composition (C) in an amount ranging between 35 and 60 wt. %, for example between 40 and 55 wt. %, based on the total weight of the polyamide composition (C).

The composition (C) may also comprise one component selected from the group consisting of reinforcing agents, tougheners, plasticizers, colorants, pigments, antistatic agents, dyes, lubricants, thermal stabilizers, light stabilizers, flame retardants, nucleating agents and antioxidants.

A large selection of reinforcing agents, also called reinforcing fibers or fillers, may be added to the composition according to the present invention. They can be selected from fibrous and particulate reinforcing agents. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50.

The reinforcing filler may be selected from mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite.

Among fibrous fillers, glass fibers are preferred; they include chopped strand A-, E-, C-, D-, S- and R-glass fibers, as described in chapter 5.2.3, p. 43-48 of Additives for Plastics Handbook, 2nd edition, John Murphy. Preferably, the filler is chosen from fibrous fillers. It is more preferably a reinforcing fiber that is able to withstand the high temperature applications.

The reinforcing agents may be present in the composition (C) in a total amount of greater than 15 wt. %, greater than 20 wt. % by weight, greater than 25 wt. % or greater than 30 wt. %, based on the total weight of the polymer composition (C). The reinforcing agents may be present in the composition (C) in a total amount of less than 65 wt. %, less than 60 wt. %, less than 55 wt. % or less than 50 wt. %, based on the total weight of the polymer composition (C).

The reinforcing filler may for example be present in the composition (C) in an amount ranging between 20 and 60 wt. %, for example between 30 and 50 wt. %, based on the total weight of the polyamide composition (C).

The composition (C) of the present invention may also comprise a toughener. A toughener is generally a low glass transition temperature (T_{g}) polymer, with a T_{g} for example below room temperature, below 0° C. or even below −25° C. As a result of its low T_{g}, the toughener are typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the composition (C) in a total amount of greater than 1 wt. %, greater than 2 wt. % or greater than 3 wt. %, based on the total weight of the composition (C). The toughener may be present in the composition (C) in a total amount of less than 30 wt. %, less than 20 wt. %, less than 15 wt. % or less than 10 wt. %, based on the total weight of the polymer composition (C).

The composition (C) may also comprise other conventional additives commonly used in the art, including plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents and antioxidants.

The composition (C) may also comprise one or more other polymers, preferably polyamides different from the polyamide (PA) of the present invention. Mention can be made notably of semi-crystalline or amorphous polyamides, such as aliphatic polyamides, semi-aromatic polyamides, and more generally the polyamides obtained by polycondensation between an aromatic or aliphatic saturated diacid and an aliphatic saturated or aromatic primary diamine, a lactam, an amino-acid or a mixture of these different monomers.

According to an embodiment, the polyamide composition (C) has:
a dielectric constant (Dk) at 2.4 GHz of less than 3.0, preferably less than 2.9, preferably less than 2.8, as measured according to ASTM D2520 (2.4 GHz), and/or
a dissipation factor (Df) at 2.4 MHz of less than 0.010, preferably less than 0.009, preferably less than 0.0089, as measured according to ASTM D2520 (2.4 GHz).

Preparation of the Polyamide Composition (C)

The invention further pertains to a method of making the composition (C) as above detailed, said method comprising melt-blending the polyamide (PA) and the specific components, e.g. a filler, a toughener, a stabilizer, and of any other optional additives.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long glass fiber), drawing extrusion molding may be used to prepare a reinforced composition.

Articles and Applications

The present invention also relates to articles comprising the polyamide (PA) of the present invention and to articles comprising the copolyamide composition (C) described above.

The article can notably be used in mobile electronics, LED packaging, oil and gas applications and plumbing.

The article can, for example, be a mobile electronic device component. As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

The mobile electronic device component may, for example, comprise a radio antenna and the composition (C). In this case, the radio antenna can be a WiFi antenna or an RFID antenna. The mobile electronic device component may also be an antenna housing.

In some embodiments, the mobile electronic device component is an antenna housing. In some such embodiments, at least a portion of the radio antenna is disposed on the polyamide composition (C). Additionally or alternatively, at least a portion of the radio antenna can be displaced from the polyamide composition (C). In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device can be at least a portion of an input device.

Examples of electric and electronics devices are connectors, contactors and switches.

The polyamide (A), polyamide composition (C) and article prepared therefrom may also be used as a gas barrier material for packaging applications, in mono or multilayer articles.

The polyamide (A), polyamide composition (C) and article prepared therefrom can also be used in automotive applications, for example in air induction systems, cooling and heating systems, drivetrain systems and fuel systems.

The article can be molded from the polyamide (PA) or polyamide composition (C) of the present invention, by any process adapted to thermoplastics, e.g. extrusion, injection molding, blow molding, rotomolding or compression molding.

The article can be printed from the polyamide (PA) or polyamide composition (C) of the present invention, by a process comprising a step of extrusion of the material, which is for example in the form of a filament, or comprising a step of laser sintering of the material, which is in this case in the form of a powder.

The present invention also relates to a method for manufacturing a three-dimensional (3D) object with an additive manufacturing system, comprising:
providing a part material comprising the polyamide (PA) or polyamide composition (C) of the present invention, and
printing layers of the three-dimensional object from the part material.

The polyamide (PA) or polyamide composition (C) can therefore be in the form of a thread or a filament to be used in a process of 3D printing, e.g. Fused Filament Fabrication, also known as Fused Deposition Modelling (FDM).

The polyamide (PA) or polyamide composition (C) can also be in the form of a powder, for example a substantially spherical powder, to be used in a process of 3D printing, e.g. Selective Laser Sintering (SLS).

Use of the Polyamides (PA), Composition (C) and Articles

The present invention relates to the use of the above-described polyamides (PA), composition (C) or articles for manufacturing a mobile electronic device component, as described above.

The present invention also relates to the use of the above-described polyamides (PA) or composition (C) for 3D printing an object.

Should the disclosure of any patents, patent applications, and publications which are incorporated herein by reference conflict with the description of the present application to the extent that it may render a term unclear, the present description shall take precedence.

### EXAMPLES

These examples demonstrate the thermal, dielectric and mechanical performances of several inventive or comparative polyamides.

Raw Materials

1,3-BAMC: 1,3-bis(aminomethyl)cyclohexane, isomer mixture, obtained from TCI

1,4-BAMC: 1,4-bis(aminomethyl)cyclohexane, isomer mixture, obtained from TCI

PXD: p-xylylenediamine obtained from Aldrich

MXD: m-xylylenediamine obtained from Aldrich

C6: 1,6-hexanediamine, obtained from Aldrich

C18: 1,18-octadecanedioic acid, Inherent™ C18, obtained from Elevance

Polyamides Preparation

All of the polyamides exemplified below were prepared according to similar processes in an electrically-heated reactor equipped with an agitator and a distillate line equipped with a pressure regulation valve. CEx1 produced at the 50-g scale in a glass sleeve in a 300-ml Parr reactor. The reactor was charged with 16.84 g (121 mmol) PXD, 37.92 g (121 mmol) C18, 23 g water and 39.7 mg phosphorous acid (0.48 mmol). The reactor was heated to a temperature of 240° C. and a pressure of 100 psig. Pressure was controlled by distillation at 100 psig and temperature increased to 280° C. over a period of 50 minutes. Pressure was lowered to atmospheric over a span of 25 minutes as temperature was increased to 287° C. Atmospheric pressure was maintained for 10 minutes followed by a nitrogen sweep for 15 minutes. Product was removed from the cooled reactor as a creamy yellow plug attached to the agitator.

Testing

Thermal Transitions (Tg, Tm)

The glass transition and melting temperatures of the various polyamides were measured using differential scanning calorimetry according to ASTM D3418 employing a heating and cooling rate of 20° C./min. Three scans were used for each DSC test: a first heat up to 340° C., followed by a first cool down to 30° C., followed by a second heat up to 350° C. The Tg and the Tm were determined from the second heat up. The glass transition and melting temperatures are tabulated in Table 1 below.

TABLE 1
mol. %

| | CEx 1 | CEx 2 | Ex 3 | CEx4 | CEx 5 | CEx 6 |
|---|---|---|---|---|---|---|
| PXD | 100 | — | — | — | — | — |
| MXD | — | — | — | 100 | 100 | — |
| C18 | 100 | 100 | 100 | 100 | — | — |
| C10 | — | — | — | — | — | 100 |
| C6 | — | — | — | — | 100 | — |
| 1,3-BAMC | — | 100 | — | — | | — |
| 1,4-BAMC | — | — | 100 | — | — | 100 |
| | Glass Transition and Melting temperatures | | | | | |
| Tg (° C.) | Nd | 62 | 69 | Nd | 78 | 108 |
| Tm (° C.) | 236 | 155 | 189 | 173 | 240 | 280 |

Compression Molding

The compression molding of 2″ by ⅛″ disks was conducted with dried granulated polymer using a Carver 8393 Laboratory Press according to conditions described in Table 2 below. The CEx1 disk was milled from the product polymer plug to the same dimensions.

TABLE 2

| | CEx 1 | CEx2 | Ex3 | CEx 4 | CEx 5 | CEx 6 |
|---|---|---|---|---|---|---|
| Molding | 285 | 210 | 270 | 270 | 270 | 320 |
| Temperature | | | | | | |
| (° C.) | | | | | | |
| Pressure | 4500 | 4500 | 4500 | 4500 | 4500 | 4500 |
| (psi) | 6000 | 6000 | 6000 | 6000 | 6000 | 6000 |
| | 4500 | 4500 | 4500 | 4500 | 4500 | 4500 |
| Times (min) | 15 | 15 | 15 | 18 | 18 | 18 |
| | 1 | 5 | 5 | 11 sec | 11 sec | 11 sec |
| | 1 | 1 | 1 | 1 | 1 | 1 |

Dielectric Performances

The dielectric constant ε and dissipation factor Df were measured according to ASTM D2520. Measurements were taken with samples that were milled from the “dry-as-molded’ compression molded discs of dimensions of 0.08 in.×0.20 in.×1.0 in.

TABLE 3
dielectric performances

| | | CEx 1 | CEx 2 | Ex 3 |
|---|---|---|---|---|
| 2.4 GHz | E | 2.76 | 2.61 | 2.62 |
| | Df | 0.0092 | 0.0088 | 0.0081 |
| | | CEx4 | CEx 5 | CEx 6 |
| 2.4 GHz | E | 2.77 | 3.26 | 2.83 |
| | Df | 0.0095 | 0.011 | 0.0088 |

The BAMC18 polyamides (CEx2 and Ex3) have better dielectric performance (lower ε and Df) than the comparative PXD18 (CEx1), MXD18 (CEx4), MXD6 (CEx5) and 1,4-BAC10 (CEx6). The 1,4-BAMC18 polyamide (Ex3) has a better dissipation factor than 1,3-BAMC18 polyamide (CEx2).

Transparency Test

While being semi-crystalline, quite surprisingly, the polyamides of the invention (CEx2 and Ex3) are clear. Reading a text through a 2 mm thick sample is possible, whereas the same does not hold true for the comparatives polyamides of CEx1, CEx4 and CEx5. A plaque of composition Ex2 was compression molded to dimensions 5 cm by 5 cm by 2 mm. The transparency measured according to ASTM D1003 was 88%. The polyamides of the invention (Ex3) demonstrate a unique combination of dielectric performance and transparency while being semi-crystalline that are desired in several applications, including in smart device applications.

1. A polyamide (PA), comprising at least 55 mol. % of recurring units (R_{PA}) according to formula (I) or formula (II), based on the total number of moles in the polyamide (A): 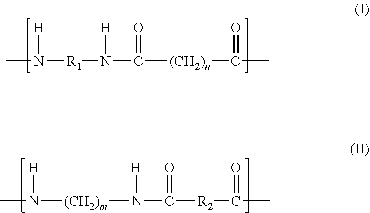
wherein:
n equals 16,
m equals 18,
R₁ is 1,4-bis(methyl)cyclohexane, and
R₂ is 1,4-bis(methyl)cyclohexane.

2. The polyamide (PA) of claim 1, comprising at least 60 mol. % of the recurring units (R_{PA}) according to formula (I) or (II), based on the total number of moles in the polyamide (A).

3. The polyamide (PA) of claim 1, wherein the polyamide is the condensation product of a mixture comprising:
at least one diamine which is 1,4-bis(aminomethyl)cyclohexane diamine, and
at least one dicarboxylic acid which is HOOC—(CH₂)₁₆—COOH, or derivative thereof.

4. The polyamide (PA) of claim 3, wherein the condensation mixture further comprises at least one of component selected from the group consisting of:
at least one dicarboxylic acid component or derivative thereof, and at least one diamine component,
at least one aminocarboxylic acid, and/or
at least one lactam.

5. The polyamide (PA) of claim 4, wherein:
the dicarboxylic acid component is selected from the group consisting of adipic acid, azelaic acid, sebacic acid, isophthalic acid, terephthalic acid, 2,6-naphthalene dicarboxylic acid, 4,4′-bibenzoic acid, 5-hydroxyisophthalic acid, 5-sulfophthalic acid, and mixture thereof, and
the diamine component is selected from the group consisting of 1,4-diaminobutane, 1,5-diamonopentane, 2-methyl-1 ,5-diaminopentane, hexamethylenediamine, 1,9-diaminononane, 2-methyl-1,8-diaminooctoane, 1,10-diaminedecane, H₂N—(CH₂)₃—O—(CH₂)₂—O(CH₂)₃—NH₂, bis(4-amino-3-methylcyclohexyl)methane (MACM), bis(4-aminocyclohexyl)methane (MACM), and mixture thereof.

6. The polyamide (PA) of claim 4, wherein the lactam is selected from the group consisting of caprolactam, laurolactam and mixture thereof.

7. The polyamide (PA) of claim 1, wherein the polyamide has a dielectric constant (Dk) at 2.4 GHz of less than 3.0, as measured according to ASTM D2520 (2.4 GHz).

8. The polyamide (PA) of claim 1, wherein the polyamide has a dissipation factor (Df) at 2.4 GHz of less than 0.010, as measured according to ASTM D2520 (2.4 GHz).

9. A composition (C), comprising:
the polyamide (PA) of claim 1, and
at least one component selected from the group consisting of reinforcing agents, tougheners, plasticizers, colorants, pigments, antistatic agents, dyes, lubricants, thermal stabilizers, light stabilizers, flame retardants, nucleating agents and antioxidants.

10. The composition (C) of claim 9, comprising from 10 wt. % to 60 wt. % of glass fibers, based on the total weight of the composition (C).

11. The composition (C) of claim 9, further comprising from 0.5 wt. % to 5 wt. % of pigment, dye or colorant selected from the group consisting of TiO2, carbon black, zinc sulfide, barium sulfate, zinc oxide, ferric oxide and any combination of two or more thereof, based on the total weight of the composition (C).

12. The composition (C) of claim 9, comprising from 40 wt. % to 70 wt. % of the polyamide (PA), based on the total weight of the composition (C).

13. An article comprising the polyamide (PA) of claim 1.

14. The article of claim 13, being a mobile electronic device article or component, a composite material or a 3D printed article.

15. The article of claim 13, being an article or a component of a mobile electronic device selected from the group consisting of a mobile phone, a personal digital assistant, a laptop computer, a tablet computer, a wearable computing device, a camera, a portable audio player, a portable radio, a global position system receiver, and a portable game console.
